(19) United States
(12) Patent Application Publication
(10) Pub. No.: US 2008/0079556 A1
(43) Pub. Date: Apr. 3, 2008

(54) Add brake lamps to vehicle front end

(76) Inventor: Ruth E. Pratt, Honolulu, HI (US)

Correspondence Address: RUTH E. PRATT, 1617-A PAULA DR, HONOLULU, HI, 96816, US

(21) Appl. No.: 11/542,059

(22) Filed: Oct. 2, 2006

(51) Int. Cl. B60Q 1/44

(52) U.S. Cl. 340/479

(57) ABSTRACT

For new car design, a second brake wire must be routed through the headlamp junction block to two red lamps located on the vehicle front that will be visible to oncoming drivers and pedestrians from the left, center and right of the vehicle. For retrofitting vehicles, brake wires, found in the lamp junction block in the trunk, may be split, adding 16 to 20 feet of new wire which is run, under vehicle flooring, through the firewall to the headlamp junction box, thence through the grill to be attached to bulbs that are the inserted into red housing and bonded to the exterior so as to be visible to oncoming drivers and pedestrians, left, center and right.

New vehicle design adds a brake wire that runs through the headlamp junction block to a new exterior lamp housing that will be visible from the front, left and right sides of the vehicle.

Retrofitting brake lamps to vehicle front ends may be accomplished by splitting existing brake wires (found in the lamp junction block in the trunk) and connecting enough new brake wire with butt connectors to reach (via under the driver's side carpet) the front exterior of the vehicle, where light bulbs are attached to those wires and the bulbs are then inserted into red lamp housings that are then bonded to the vehicle front so as to be visible from the left, center and right of the vehicle, making the brake status of each vehicle known to oncoming drivers and pedestrians.

1. This is a new utility using old art to expand braking information in a new vehicular front end configuration that creates a new source of highway safety by providing brake status information to oncoming traffic, left, center and right to address new information that only 5% of 42,636 traffic fatalities in 2004 were due to rear-end collisions.
